(19) United States
(12) Patent Application Publication
(10) Pub. No.: US 2008/0229868 A1
(43) Pub. Date: Sep. 25, 2008

(54) Brake Pedal Device For Effecting Service Braking and Lock Braking

(76) Inventor: Jean Populaire, Creil (FR)

Correspondence Address: LADAS & PARRY LLP, 224 SOUTH MICHIGAN AVENUE, SUITE 1600, CHICAGO, IL, 60604, US

(21) Appl. No.: 10/583,794

(22) PCT Filed: Dec. 9, 2004
(86) PCT No.: PCT/FR2004/003168

§ 371 Date: Jun. 21, 2006

(30) Foreign Application Priority Data
Dec. 23, 2003 (FR) 0315231

(51) Int. Cl. B60T 7/04

(52) U.S. Cl. 74/512

(57) ABSTRACT

A brake pedal device suitable for being actuated to effect service braking and lock braking, said brake pedal device having a first brake pedal element and a second brake pedal element, which elements are suitable for being moved by being depressed for effecting braking. Depression of at least the first brake pedal element is suitable for causing service braking to take place. The device further has locking means which are suitable for being activated by moving the second brake pedal element over a determined stroke only, so as to hold said second brake pedal element in the locked position for lock braking, and unlocking means which are suitable for being activated by depressing the first brake pedal element so as to unlock the locking means and so as to release the second brake pedal element.

The invention relates to a brake pedal device suitable for being actuated to effect service braking and lock braking for a vehicle.

Service braking is used while a vehicle is moving in order to slow it down and/or to stop it. Service braking is a function of the pressure exerted by the foot of a user on the brake pedal.

Lock braking makes it possible to hold the vehicle stationary while said vehicle is working. Lock braking is particularly advantageous for site vehicles that need to be held stationary, e.g. while digging is being performed by a digger scoop.

Such devices are known, for example, from Application WO 96/01199 which describes a brake device comprising a main brake pedal and an accessory element. By acting on the accessory element, the main brake pedal can be locked and lock braking is then activated. Service braking is obtained by depressing the main brake pedal without taking any particular action on the accessory element. Lock braking is obtained by depressing both the main brake pedal and the accessory element simultaneously to the maximum extent. Holding that lock braking position is obtained by locking the main brake pedal, via a locking device that comprises the accessory element and that is implemented by swiveling and moving the foot so as to release said accessory element while the brake pedal remains depressed. Lock braking is deactivated as soon as the accessory element is depressed.

Unfortunately, in that brake pedal device, the risk of unintentional and dangerous lock braking taking place, although limited, does exist whenever a user depresses the main brake pedal and the accessory element simultaneously and fully when applying the brakes for emergency braking. A user who intends to use service braking only but who depresses the main brake pedal fully while simultaneously catching the foot on the accessory element might activate lock braking, giving rise to the vehicle being held stationary unintentionally if said user moves the foot slightly, thereby unfortunately releasing the accessory member without releasing the brake pedal at the same time. It is then necessary for the user to deactivate lock braking urgently by depressing the accessory element.

Ergonomically, that device also suffers from the drawback of requiring a plurality of successive actions from the foot, combining depress movements and swivel movements, in order to activate and deactivate lock braking. In particular, in order to activate lock braking, it is essential to continue to press with the foot on the depressed brake pedal while turning, swiveling, or moving said foot in order to release the accessory element. That movement is not natural and it is awkward or even painful.

Brake pedal devices are also known that comprise a main brake pedal, a locking hook, and a locking pin, as well as a locking deactivation tab. In such known devices, depressing the main brake pedal to the maximum extent makes it possible to lock said main brake pedal in a lock braking position. In order to unlock the lock braking, it is necessary to depress the locking deactivation tab.

However, in order to actuate service braking while avoiding actuating lock braking, it is necessary to depress both the main brake pedal and the locking deactivation tab simultaneously, so that depressing the main brake pedal does not lead to said main brake pedal being locked for lock braking.

Thus, in such known brake devices, lock braking is activated as from maximum service braking. It can thus be understood that, in an emergency braking situation, a user who is driving on the road and who wishes to activate service braking only, but who depresses the brake pedal to the fullest extent, might activate undesired lock braking.

An object of the invention is to provide a brake pedal device that is ergonomic, that makes it possible to activate service braking without any risk of activating lock braking, and that makes it possible to activate and to deactivate lock braking by a single and simple action of the foot.

This object of the invention is achieved by the fact that the brake pedal device comprises a first brake pedal element and a second brake pedal element, which elements are suitable for being moved by being depressed for effecting braking, depressing at least the first brake pedal element being suitable for causing service braking to take place, and by the fact that the device further comprises locking means which are suitable for being activated by moving the second brake pedal element over a determined stroke only, so as to hold said second brake pedal element in the locked position for lock braking, and unlocking means which are suitable for being activated by depressing the first brake pedal element so as to unlock the locking means and so as to release the second brake pedal element.

Thus, service braking is obtained by depressing at least the first brake pedal element, or by jointly depressing the first and the second brake pedal elements. Since the brake pedal device includes unlocking means that are suitable for being activated by depressing the first brake pedal element, it can be understood that, even when service braking is obtained by depressing the first brake pedal element to the maximum extent, there is no risk of such service braking activating lock braking. Lock braking is obtained by an intentional operation by the user, which corresponds to depressing the second brake pedal element only.

In addition, when lock braking is not necessary, it can be deactivated merely by depressing the first brake pedal element.

By using known return means, the first and second brake pedal means are caused to return to their high positions in which no braking takes place when no pressure is exerted on them.

The locking means preferably comprise a retaining member that is stationary and a catch member that is connected to the second brake pedal element, said catch member being suitable for engaging with said retaining member for locking the second brake pedal element in the locked position.

Thus, when the second brake pedal element is moved by intentional depressing by the user, the catch member that is connected to said second brake pedal element comes to engage with the retaining member so as to lock the second brake pedal element in the locked position, i.e. in the lock braking position.

The unlocking means preferably comprise a first unlocking member united with the first brake pedal element and a second unlocking member united with the second brake pedal element, said first and second unlocking members being suitable for co-operating to bring the catch member into a disengagement position in which it is incapable of engaging with the retaining member.

Merely by depressing the first brake pedal element, it is possible to activate said unlocking means so as to unlock the locking means by bringing the catch member into a disengagement position, thereby releasing the second brake pedal element. Preferably, in a first variant, the first unlocking member comprises a cam actuator and the second unlocking member comprises a cam, the cam actuator being suitable for coming into contact with the cam, when the first brake pedal element is depressed, so as to bring the catch member into the disengagement position.

Thus, by depressing the first brake pedal element, the cam actuator urges the cam and brings the catch member into a disengagement position, thereby preventing said catch member from being engaged or releasing it if it was engaged. It follows that depressing the first brake pedal element makes it possible to prevent activation of lock braking or to deactivate lock braking if lock braking was activated.

Preferably, the first unlocking member comprises an actuating surface and the second unlocking member comprises a lever, the actuating surface being suitable for coming into contact with the lever when the first brake pedal element is depressed, so as to bring the catch member into the disengagement position.

Thus, in a manner analogous to the first variant, as soon as the first unlocking member is depressed, the actuating surface comes to co-operate with the lever which brings the catch member into a disengagement position in which it can no longer be engaged with the retaining member or is disengaged therefrom.

Regardless of the variant in question, the brake pedal device preferably further comprises drive means making it possible to move the second brake pedal element with the first brake pedal element merely by depressing said first brake pedal element.

Thus, in order to obtain service braking, the user does not need to depress both of the brake pedal elements. As it moves, the first brake pedal element being moved by depressing said first brake pedal element drives the second brake pedal element with it.

The first and second brake pedal elements preferably have depress surfaces which are of complementary shape so that, when the first and second brake pedal elements are in the same plane, said depress surfaces form a brake pedal having a depress surface of closed outline that is advantageously substantially rectangular.

In a manner such as to facilitate distinguishing between the first and the second brake pedal elements, it is possible to make provision for the first brake pedal element to have a larger area at least at the portion where the foot naturally presses, so that actuating said first brake pedal element is natural during service braking. The second brake pedal element then has a smaller area at least where the foot naturally presses, so that actuating said second brake pedal element in isolated manner for locking the brake pedal for lock braking can only be intentional and targeted.

The invention will be well understood and its advantages will appear more clearly from the following detailed description of embodiments of the invention shown by way of non-limiting example.

The description refers to the accompanying drawings, in which:

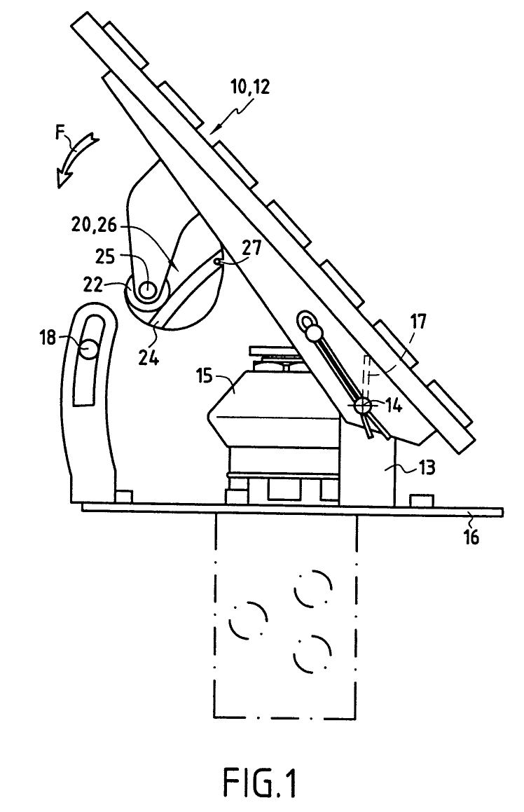

FIG. 1 is a side view of a first embodiment of a brake pedal device in the high position;

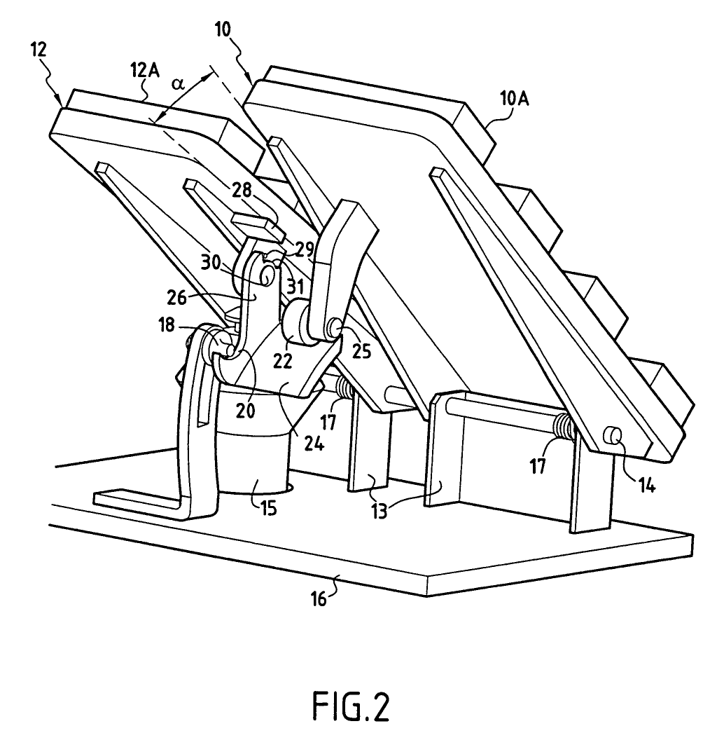

FIG. 2 is a perspective view of the device of FIG. 1 in the lock braking position;

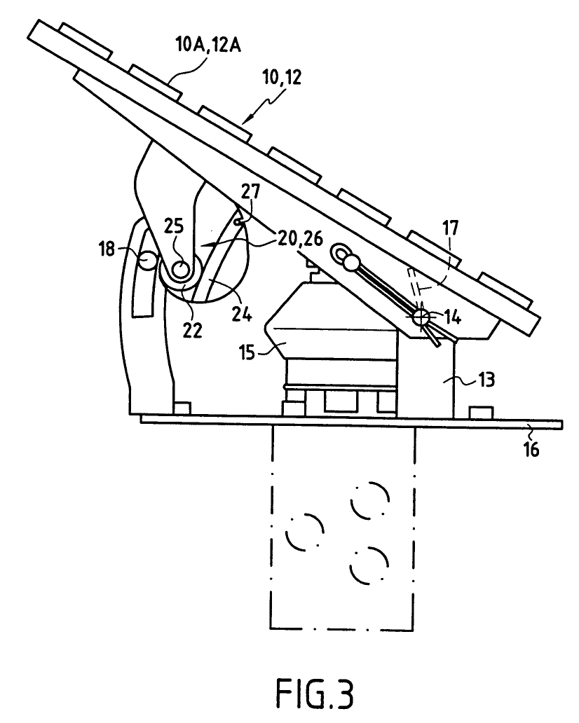

FIG. 3 is a side view of the brake pedal device of FIG. 1 in a service braking position;

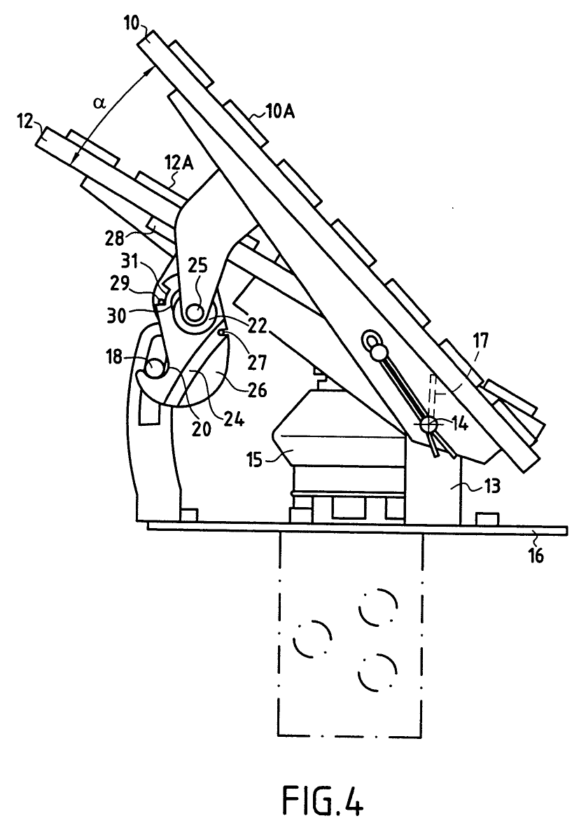

FIG. 4 shows a side view of the device of FIG. 1 in the lock braking position;

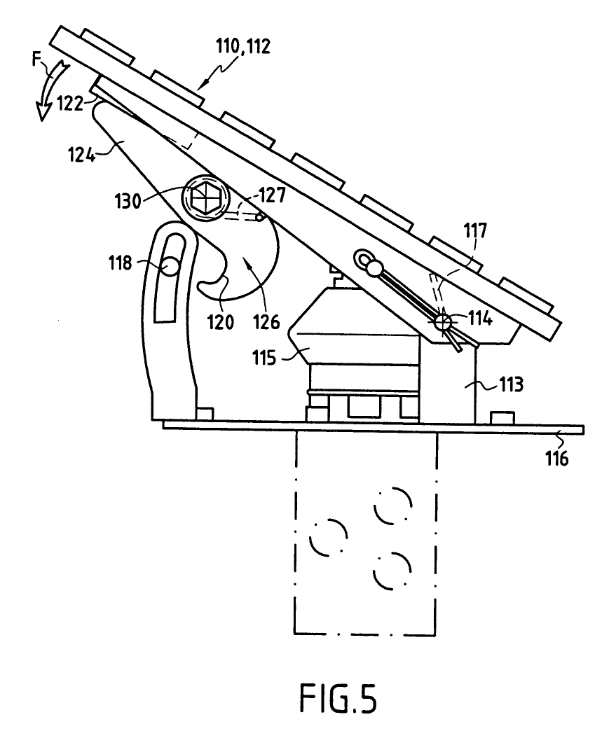

FIG. 5 shows a side view of another variant of a brake pedal device in the service braking position;

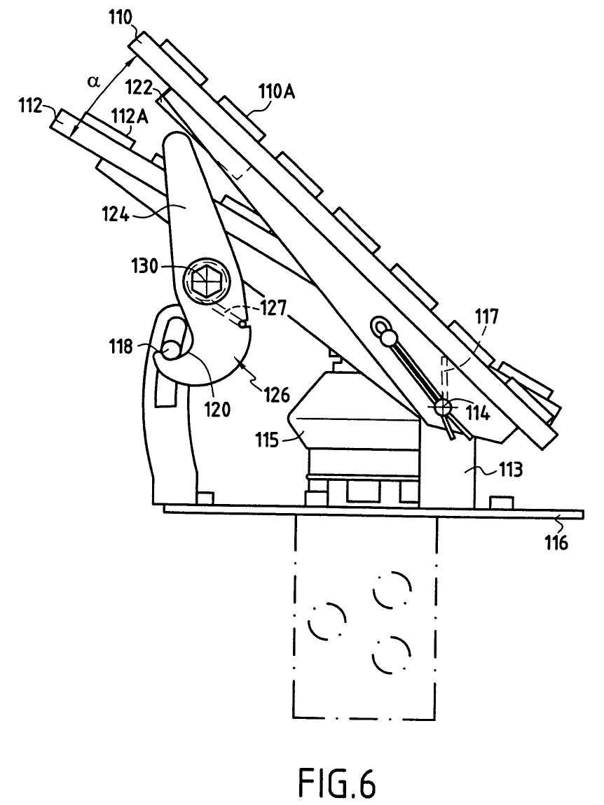

FIG. 6 shows a side view of the device of FIG. 5 in the lock braking position;

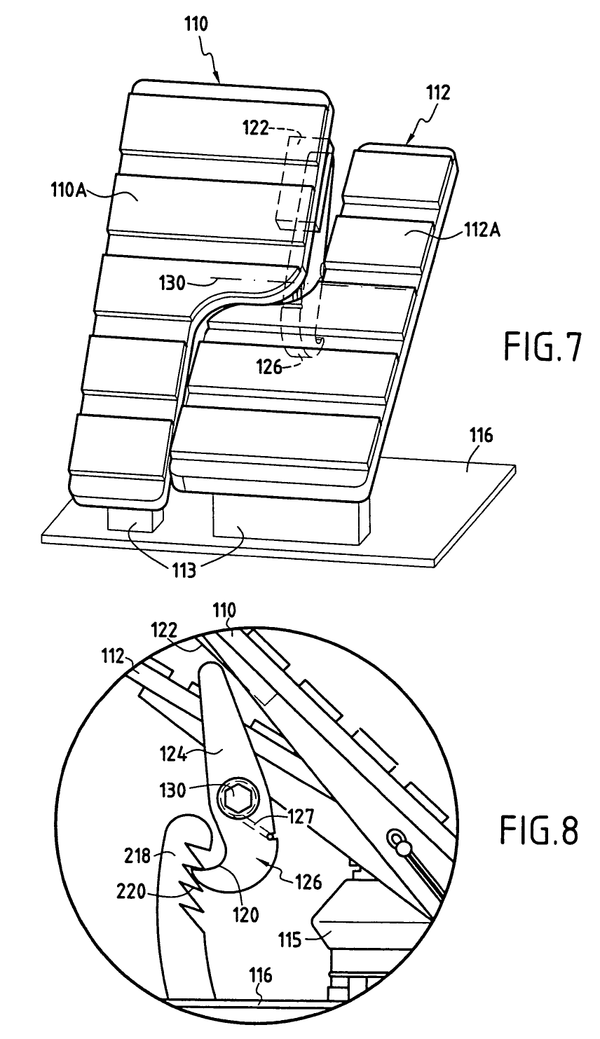

FIG. 7 shows a perspective view of FIG. 5;

FIG. 8 is a diagrammatic side view of a detail of another variant of the brake pedal device;

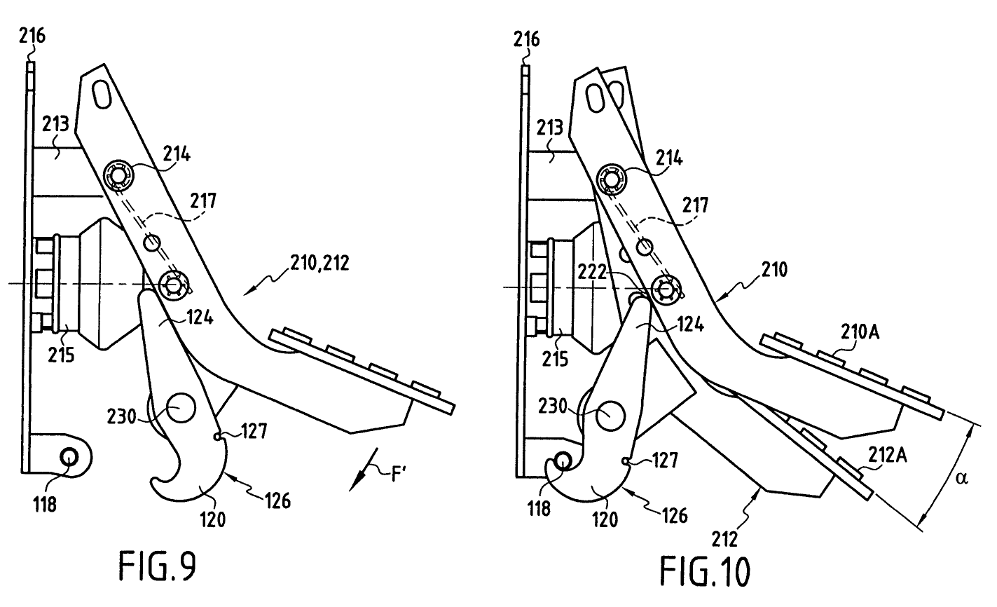

FIG. 9 is a side view of a second embodiment of a brake pedal device in the high position;

FIG. 10 is a side view of the brake pedal device of FIG. 9, in the lock braking position; and

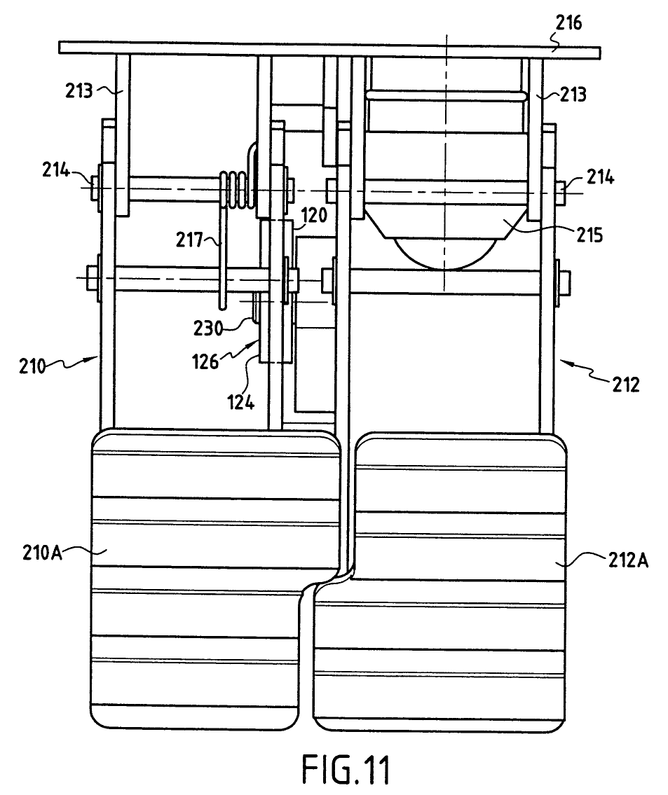

FIG. 11 is a view from above of the device of FIG. 9.

FIG. 1 shows a bake pedal device which includes first and second brake pedal elements or plates 10 and 12 that are adjacent and that are mounted to pivot about a common stationary pedal pin and axis 14 on a base 16. Known resilient means 17 make it possible to hold the first and second brake pedal elements 10 and 12 in a high position, corresponding to absence of braking, in the absence of any depressing, and urging them to return to their high position from a service braking low position when the depressing on the first brake pedal element and/or on the second brake pedal element ceases.

The brake pedal device includes locking means, constituted in this example by a retaining member 18 fastened to the base 16 and by a catch member 20 connected to the second brake pedal element 12.

The brake pedal device further includes unlocking means, constituted in this example by a first unlocking member 22 secured to the first brake pedal element 10, and by a second unlocking member 24 united with the second brake pedal element 12. The second unlocking member, constituted by a cam 24 in this example, is united with the catch member 20 and forms one hook-shaped piece 26 therewith, the hook being suitable for pivoting about a pivot pin 30 connected to the second brake pedal element 12 between two positions determined by a partial annular recess 31 whose ends can come into abutment against a stud 29 fastened to the second brake pedal element 12.

The first locking member, constituted by a cam actuator 22 in this example, is suitable for coming into contact with the cam 24 so as to bring the catch member 20 into a disengagement position in which the locking means cannot be activated, the hook 26 being caused to pivot by the cam actuator 22 being depressed against the cam 24.

As shown in FIG. 2, the brake pedal device includes drive means that comprise an extension 28 that is united with the second brake pedal element 12 and that extends into the path over which the first brake pedal element 10 moves, so that depressing the first brake pedal element 10 also drives the second brake pedal element 12.

The first brake pedal element 10 preferably presents a depress area 10A that is larger so that actuating it is natural for service braking, and so that such actuation makes emergency braking possible without any risk of locking, whereas the second brake pedal element 12 presents a depress portion 12A that is of smaller area so that actuating it in isolation for locking the second brake pedal element 12 for lock braking can only be intentional and targeted.

Operation of such a brake pedal device is described below.

Starting from the high position in which no braking takes place, as shown in FIG. 1, depressing at least the first brake pedal element 10 in the direction indicated by arrow F causes the first brake pedal element 10 to move towards a braking low position, by moving closer to the base 16. Since the first brake pedal element 10 moving causes the second brake pedal element 12 to move via the extension 28, the first and second brake pedal elements move in the direction indicated by arrow F towards the base 16. The second brake pedal element 12 moving makes it possible to act on a braking modulator 15 of known type that is situated under said second brake pedal element 12 and that makes it possible for braking to take place progressively, thereby improving comfort and safety.

Another consequence of depressing the first brake pedal element 10 is that the cam actuator 22 finds itself in contact with the cam 24 so that the catch member 20 finds itself in the disengagement position, in which it is not possible for said catch member to engage with the retaining member 18. This is thus a service braking situation, with the hook 26 in the disengagement position, i.e. with no risk of lock braking being activated, as shown in FIG. 3.

The hook 26 which is connected to the second brake pedal element 12 via its pivot pin 30 that is situated below the second brake pedal element 12, and that extends to under the first brake pedal element 10. Thus, the cam 24 and the cam actuator 22 are situated in vertical alignment so that they suitable for co-operating as a function of the respective positions of the first and second brake pedal elements 10 and 12. In this example, the cam actuator 22 comprises a wheel 22 which is suitable for moving in rotation about its wheel pin 22 and which is suitable for co-operating with the cam 24 by running therealong or indeed for being spaced apart therefrom. Therefore, as soon as the user depresses at least the first brake pedal element, the wheel 22 runs along the cam 24 so that the hook 26 is spaced apart from the retaining member 18 and cannot engage therewith.

As soon as the user releases the pressure exerted by the foot on the first and second brake pedal elements 10 and 12, said brake pedal elements return to their high position (shown in FIG. 1) by moving away from the base 16 under drive from the resilient device 17.

In order to perform lock braking, the user must press on the second brake pedal 12 only, over an angular stroke α determined so that the hook 26, and in particular the catch member 20, can find itself facing the retaining member 18. Preferably, it is possible for the user to act merely by depressing the second element 12 alone in targeted manner. However, it is possible for the user to act simultaneously on both elements 10 and 12. In which case, the user must then release the first element 10 by intentionally swiveling the foot, so that it is possible to lock the second brake pedal element so as to actuate lock braking. The hook 26 is tilt mounted and it is urged to return to the engagement position by a return spring, e.g. a torsion spring 27 presenting a first branch snap-fastened to the catch member 20, a winding around the pin 30, and a second branch snap-fastened under the second brake pedal element 12. In order to engage the retaining member 18, the hook 26 retracts by passing against said retaining member 18 and returns to the engagement position if the wheel 22 does not exert any force on the cam 24. This position is shown in FIGS. 2 and 4. Naturally, the angular stroke α indicated in FIGS. 2 and 4 must be increased slightly at the time of locking which takes place only once the catch member 20 has returned to the engagement position after having gone past the retaining member 18.

In this position, the cam 24 is spaced apart from the cam actuator 22, and the hook 26 can pivot about its pivot pin 30 connected to the second brake pedal element 12 and can then engage with the retaining member 18. Whereupon, even if the user releases the pressure exerted on the second brake pedal element 12, said second brake pedal element remains in the locked position and lock braking is maintained.

In order to deactivate the lock braking, the user merely needs to exert pressure on the first brake pedal element 10, thereby causing said first pedal element to move towards the base 16 and thus to move the cam actuator 11 towards the cam 24. As soon as the cam actuator 22 comes into contact with the cam 24, the pressure exerted on the first brake pedal element 10 by the user is transmitted to the hook 26 by the wheel 22 which, by running on the cam 24 causes the hook 26 to tilt so that the catch member 20 is released from the retaining member 18. Then, releasing the pressure exerted on the first brake pedal element causes the first and second brake pedal elements 10 and 12 to move towards their high position in which no braking takes place.

FIGS. 5, 6 and 7 show another variant of a brake pedal device. The brake pedal device has a first brake pedal element 110 and a second brake pedal element 112, which elements are adjacent to each other and pivot about a common pedal pin and axis 114 connected to a base 116. This second variant differs from the above-described first variant in that the unlocking means are different.

The unlocking means comprise a catch member 120 suitable for co-operating with a retaining member 118 fastened to the base 116 in a manner such as to engage therewith to lock the second brake pedal element 112 in the locked position in which lock braking is obtained.

The hook 126 is situated under the first brake pedal element 110 and its pivot pin 130 connected to the second brake pedal 112 also extends therebeyond under the first brake pedal element 110. The hook 126 comprises a catch member 120 and the second locking member, which is a lever 124 in this example, and both said catch member and said second locking member extend under the first brake pedal element 110, on either side of the pivot pin 130. Therefore, the first brake pedal element 110 moving towards the base 116 in the direction indicated by arrow F causes said first brake element to co-operate with the lever 124 of the hook 126 so that the catch member 120 finds itself in a disengagement position and so that lock braking is not possible to achieve.

In this example, an actuating surface 122 that is suitable for coming into contact with the lever 124 is provided on the first brake pedal element 110 which acts as the first unlocking member.

A resilient device 117 of known type enables the first and second brake pedal elements 110 and 112 to return to the high position (not shown) in which no braking takes place when the user ceases to exert pressure on the first and second brake pedal elements 110 and 112, so long as the second brake pedal element 112 is not engaged in the locking position.

In order to obtain service braking, it is necessary merely for the user to depress at least the first brake pedal element 110, said first brake pedal element moving causing the second brake pedal element 112 to move by means of its actuating surface 112 co-operating with the lever 124, and by means of the hook 126 tilting into its disengagement position. The second brake pedal element 112 moving then makes it possible, as described in the first variant, to act on a braking modulator 115 of known type that is situated under said second brake pedal element 112.

In order to actuate lock braking, the user must depress the second brake pedal element 112 only. Provision can be made for the center of gravity of the hook 126 to be situated below its pivot pin and axis 130, by making provision, for example, for that portion of the hook 126 which comprises the catch member 120 to be heavier than that portion of the hook 126 which comprises the lever 124, so that, as soon as the second brake pedal element 112 moves away from the first brake pedal element 110, the hook 126 pivots naturally about its pivot pin 130 while taking up a position in which the catch member 130 is capable of coming to engage with the retaining member 118. In order to guarantee this good positioning in another manner or in additional manner with such a hook, as described for the first variant, a return spring 127 (similar to the spring 27 of the first variant) can be provided for urging the hook 126 back into the position in which it is capable of engaging with the retaining member whenever the first brake pedal element 110 is situated in its high position.

Thus, after the second brake pedal element 112 has traveled over a determined angular stroke α, the hook 126 comes to engage with the retaining member 118 and holds the second brake pedal element in the locked position for lock braking. As in the first variant, the angular stroke α shown in FIG. 6 must be increased slightly at the time of locking, in order to enable the hook 126 to go past the retaining member 118 before moving back to engage therewith.

Merely exerting pressure on the first brake pedal element 110 causes the hook 126 to tilt about its pivot pin 130, thereby causing the catch member 120 to disengage from the retaining member 118 so that the second brake pedal element 112 is released, and so that the locking means are unlocked. Therefore, when the user releases the pressure exerted on the first brake pedal element, the first and second brake pedal elements 110 and 112 return to their high position in which no braking takes place.

As shown in FIG. 7, the first brake pedal element 110 advantageously has a larger area at the portion 110A where the foot naturally presses so that actuating said first brake pedal element is natural for service braking and makes emergency braking possible with no risk of locking, whereas the second brake pedal element 112 has a portion 112A of smaller area where the foot naturally presses so that actuating lock braking can only be intentional and targeted. The first and second brake pedal elements 110 and 112 have shapes such that they are interfitting so as together to constitute a brake pedal of usual shape that is substantially rectangular in its plane when the first and second brake pedal elements 110 and 112 are lying in the same plane.

The locking means are activated in the locked position so as to obtain a lock braking mode by depressing the second brake pedal element 112 only into its low position, the first brake pedal element 110 then being free.

The unlocked position corresponding to service braking is obtained by depressing the first element 110, the unlocking means then preventing the second brake pedal element 112 from being locked.

FIG. 7 clearly shows that the hook 126 is situated under the brake pedal element 110 so that said brake pedal element 110 moving causes the second brake pedal element 112 to move by means of the brake pedal element 110 co-operating with the hook 126.

In FIGS. 1 to 7, the position of the retaining member 18, 118 can be adjusted relative to the base, e.g. by providing a stud that is locked in a substantially vertical oblong hole.

In an advantageous variant, the locking means have a plurality of locking positions.

FIG. 8 shows such a variant brake pedal device. All of the elements that are identical to the elements of the first variant have like numerical references. This variant differs in that a lock braking torque that is determined and variable can be applied depending on the pressure exerted on the second brake pedal element, whereas only a single maximum braking torque could be achieved for the above-mentioned variants during lock braking.

FIG. 8 shows the brake pedal device in the lock braking position in which the second brake pedal element 112 is in the low position while the first brake pedal element 110 is in the high position.

In this position, in a manner analogous to the above-mentioned description of the second variant, the lever 124 of the hook 126 does not co-operate with the actuating surface 122 of the first brake pedal element 110, and the hook 126 finds itself in a position such that its catch member 120 co-operates with a retaining member 218.

The retaining member 218 is provided with a rack, constituted, in this example, by serrations 220 with each of which the catch member is capable of co-operating as a function of the position in which the second brake pedal element 112 finds itself, thereby making various locked positions possible, each of which corresponds to a determined lock braking stroke and to a determined lock braking torque.

Thus, depending on the desired lock braking, the user depresses the second brake pedal element 112 to a greater or to a lesser extent so that the catch member 120 engages with a selected one of the serrations 220 on the retaining member 218. The lock braking is deactivated as described above, merely by the foot depressing the first brake pedal element 110 so as move said first brake pedal element closer to the base 116.

In the present invention, the locked position does not correspond to the maximum stroke because a short over-stroke is necessary to enable locking to take place. Lock braking thus has a value slightly smaller than the value of the maximum service braking, e.g. the pressure of the braking modulator is 120 bars for lock braking, and 125 bars for service braking.

FIGS. 9 and 10 show a second embodiment of a brake pedal device. The brake pedal device comprises a first brake pedal element 210 and a second brake pedal element 212, which elements are adjacent and pivot about a common pedal pin and axis 214 that is connected to a panel-mount support 216. The second embodiment differs from the above-described first embodiment in that the arrangement of the device is different. In particular, the base 16 is replaced with a panel-mount support which is angularly positioned differently and from which the pedal elements are suspended.

In the first embodiment, the pedal elements 10 and 12 (or 110 and 112) are fastened to the floor (e.g. via the base 16) so that almost the entire foot of a user is situated over the depress portion 110A of the pedal element, whereas in the second embodiment, the pedal elements are suspended and the depress portions are small. Therefore, in the second embodiment, the depress portions 210A and 212A do not make it possible for the foot to bear fully against them during braking.

In the first embodiment, shown in FIGS. 1 to 8, the base 16 (116) extends substantially in a plane that is substantially parallel to the mean plane of the chassis of the vehicle, i.e. substantially horizontally (when the vehicle is in the usual position). In this way, the brake pedal elements 10 and 12 (110 and 112) are situated above the base 16 (116). In which case, the braking modulator 15 (115) extends under the brake pedal elements 10 and 12 (110 and 112), substantially vertically. The same applies for the support 13 (113) for the pedal pin and axis 14 (114). The pedal pin and axis 14 (114) is situated in the vicinity of the bottoms of the brake pedal elements 10 and 12 (110 and 112) and is close to the heel of a user of the brake device, preferably below the retaining member 18 that is fastened to the base 16.

In the second embodiment, the panel-mount support 216 also extends substantially in a plane, but it is inclined relative to the mean plane of the chassis of the vehicle. In this example, the panel-mount support 216 extends in a plane orthogonal to the mean plane of the chassis of the vehicle, i.e. substantially vertically (when the vehicle is in the usual position). In this way, the brake pedal elements 210 and 212 are no longer situated above the base, as they are in the first embodiment, but rather they extend on one side of the panel-mount support 216. In the second embodiment, the braking modulator 215 extends between the panel-mount support 216 and the pedals, substantially horizontally. The same applies to the support 213 of the pedal pin 214.

In the second embodiment, the pedal pin 214 is situated in the vicinity of the tops of the brake pedal elements 210 and 212. Indeed, the pedal pin 214 is situated above the retaining member 118 fastened to the panel-mount support 216.

As a result of these various arrangements, in the first embodiment, the brake pedal elements 10 and 12 (110 and 112) are actuated by the foot of the user depressing the top of the pedal (pressure exerted by the ball of the foot) in the direction indicated by arrow F, whereas, in the second embodiment, the pedal elements 210 and 212 are actuated by the foot of the user depressing the pedal elements in the direction indicated by arrow F′, this direction being on the side of the pivot axis 214 of the pedal elements that is nearer to the user, unlike the direction indicated by arrow F that is on the other side of the corresponding pivot axis 114 that is farther from the user. Braking is then preferably effected by depressing with the ball of the foot only, the heel not being situated on the pedal element, but rather generally remaining in contact with the floor of the vehicle.

The unlocking means are of the type described in any one of the variants of the first embodiment. For example, using the unlocking means described in the second variant, they comprise a catch member 120 suitable for co-operating with a retaining member 118 fastened to the panel-mount support 216 so as to engage therewith for locking the second brake pedal element 212 in the locked position in which lock braking is obtained.

The hook 126 is situated under the first brake pedal element 210 and its pivot pin 230 connected to the second brake pedal element 212 also extends therebeyond under the first brake pedal element 210.

However, unlike in the first embodiment in which the unlocking means are situated at the top of the brake pedal elements, and higher than the pedal pin 14 (114) in that example, the pivot pin and axis 230 in the second embodiment is situated below the pedal axis 214, at the bottom of the brake pedal elements 210 and 212. The arrangement of the locking means and of the support of the pedal elements are inverted from one embodiment to the other, relative to the braking modulator.

When the first brake pedal element 210 moves towards the panel-mount support 216 in the direction indicated by arrow F′, the pedal element 210 is brought into co-operation with the lever 124 of the hook 126 so that the catch member 120 finds itself in the disengagement position, and so that lock braking cannot be achieved, as shown in FIG. 9.

Thus, in order to obtain service braking, it suffices for the user to depress at least the first brake pedal element 210 in the direction indicated by arrow F′, the first brake pedal element moving causing the second brake pedal element 212 to move by means of its actuating surface 222 co-operating with the lever 124, and by means of the hook 126 tilting into the disengagement position. The second brake pedal element 212 moving then makes it possible to act, as described above, on the braking modulator 215 which is situated under said brake pedal element 212.

In order to actuate lock braking, the user must depress the second brake pedal element 212 only. The return spring 127 makes it possible to bring the hook 126 into the position in which it is suitable for engaging with the retaining member whenever the first brake pedal element 210 finds itself in its high position.

After the second brake pedal element 212 has traveled over a determined angular stroke α, the hook 126 comes to engage with the retaining member 118 and holds the second brake pedal element 212 in the locked position for lock braking.

Merely depressing the first brake pedal element 210 makes it possible to tilt the hook 126 about its pivot pin and axis 230 and thus to disengage the catch member 120 from the retaining member 118 so that the second brake pedal element 212 is released and so that the locking means are unlocked. It follows that, when the user releases the pressure exerted on the first brake pedal element 210, the first and second brake pedal elements 210 and 212 return to their high position in which no braking takes place.

As in the first embodiment shown in FIG. 7, it is also possible, in this second embodiment shown in FIG. 11, for a larger area to be provided at the portion 210A on which the ball of the foot naturally presses so that actuating it is natural for service braking and makes emergency braking possible without any risk of locking. The second brake pedal element 212 then has a portion 212A of smaller area where the ball of the foot is naturally applied so that actuating lock braking can only be intentional and targeted. The first and second brake pedal elements 210 and 212 have shapes such that they are interfitting to constitute together an overall brake pedal 211 of usual shape that is substantially rectangular in its plane when the first and second brake pedal elements 210 and 212 are lying in the same plane.

1-16. (canceled)

17. A brake pedal device suitable for being actuated to effect service braking and lock braking, said brake pedal device comprising a first brake pedal element and a second brake pedal element, which elements are suitable for being moved by being depressed for effecting braking, depressing at least the first brake pedal element being suitable for causing service braking to take place, and the device further comprising a locking mechanism suitable and arranged for being activated by moving the second brake pedal element over a determined stroke only, so as to hold said second brake pedal element in a locked position for lock braking, and an unlocking mechanism suitable and arranged for being activated by depressing the first brake pedal element so as to unlock the locking mechanism and so as to release the second brake pedal element.

18. A device according to claim 17, wherein the locking mechanism comprises a retaining member that is stationary and a catch member that is connected to the second brake pedal element, said catch member being suitable and arranged for engaging with said retaining member for locking the second brake pedal element in the locked position.

19. A device according to claim 18, wherein the unlocking mechanism comprises a first unlocking member united with the first brake pedal element and a second unlocking member united with the second brake pedal element, said first and second unlocking members being suitable and arranged for co-operating to bring the catch member into a disengagement position in which catch member is incapable of engaging with the retaining member.

20. A device according to claim 19, wherein the second unlocking member is united with the catch member.

21. A device according to claim 20, further comprising a hook suitable and arranged for pivoting about a pivot pin and axis united with the second brake pedal element, said hook comprising the catch member and the second unlocking member.

22. A device according to claim 20, wherein the first unlocking member comprises a cam actuator, and the second unlocking member comprises a cam, and the cam actuator being suitable and arranged for coming into contact with the cam when the first brake pedal element is depressed, so as to bring the catch member into the disengagement position.

23. A device according to claim 20, wherein the first unlocking member comprises an actuating surface, and the second unlocking member comprises a lever, and the actuating surface being suitable and arranged for coming into contact with the lever when the first brake pedal element is depressed, so as to bring the catch member into the disengagement position.

24. A device according to claim 21, wherein the first unlocking member comprises an actuating surface, and the second unlocking member comprises a lever, and the actuating surface being suitable and arranged for coming into contact with the lever when the first brake pedal element is depressed, so as to bring the catch member into the disengagement position, and the catch member and the lever extending on either side of the pivot pin and axis.

25. A device according to claim 17, further comprising a drive member suitable and arranged for causing the second brake pedal element to move with the first brake pedal element by depressing said first brake pedal element.

26. A device according to claim 25, wherein the drive member is formed by a protruding member that is united with the second brake pedal element and that extends into the path along which the first brake pedal element moves.

27. A device according to claim 21, wherein the hook extends at least in part into the path along which the first brake pedal element moves.

28. A device according to claim 17, wherein the first and second brake pedal elements have depress surfaces which are of complementary shape so that, when the first and second brake pedal elements are in a same plane, said depress surfaces form a brake pedal having a depress surface of closed outline.

29. A device according to claim 28, wherein said closed outline is substantially rectangular.

30. A device according to claim 17, wherein the first and second brake pedal elements are adjacent.

31. A device according to claim 17, wherein the first and second brake pedal elements pivot about a same brake pedal pin and axis.

32. A device according to claim 17, wherein the locking means have a plurality of locking positions.

33. A device according to claim 18, wherein the retaining member is provided with a rack.
